(19) United States
(12) Patent Application Publication
(10) Pub. No.: US 2024/0036325 A1
(43) Pub. Date: Feb. 1, 2024

(54) Optical Systems with Sequential Illumination

(71) Applicant: Apple Inc., Cupertino, CA (US)

(72) Inventors: Itai Afek, Kefar Sava (IL); Ariel Lipson, Tel Aviv (IL); Eran Tal, Petah Tikva (IL); Mark R. Ayres, Boulder, CO (US); Ken Anderson, Longmont, CO (US); Maria I. Campana, Boulder, CO (US); Daniel Ott, Boulder, CO (US); Roei Remez, Tel Aviv (IL); Sagee Rosen, Netzer Sereni (IL)

(21) Appl. No.: 18/349,501

(22) Filed: Jul. 10, 2023

Related U.S. Application Data
(60) Provisional application No. 63/392,686, filed on Jul. 27, 2022.

(51) Int. Cl. G02B 27/01; G02B 27/00; G02B 5/32; G02B 5/02; G02B 26/08; G02B 26/10; F21V 8/00; G02B 17/00

(52) U.S. Cl. CPC G02B 27/0172; G02B 27/0093; G02B 5/32; G02B 5/0252; G02B 26/0858; G02B 26/105; G02B 6/0036; G02B 6/0025; G02B 17/006; G02B 2027/0174; G02B 2027/0138

(57) ABSTRACT

A display may include an optical emitter that emits infrared light, a first coupler that couples the infrared light into a waveguide, and a second optical coupler that couples the infrared light out of the waveguide and towards the eye box. The infrared light may reflect off an eye as reflected light. The second optical coupler may couple the reflected light into the waveguide and the first optical coupler may couple the reflected light out of the waveguide and towards a camera for performing gaze tracking operations based on the sensor data. The display may sequentially illuminate different regions of the eye with the infrared light at different times using a scanning mirror, an array of light sources, or a wavelength-adjustable light source and gratings. This may minimize infrared light scattering, which minimizes background generation and maximizes signal-to-noise ratio for gaze tracking operations.

This application claims the benefit of U.S. Provisional Patent Application No. 63/392,686, filed Jul. 27, 2022, which is hereby incorporated by reference herein in its entirety.

### BACKGROUND

This disclosure relates to optical systems such as optical systems in electronic devices having displays.

Electronic devices can include displays that provide images near the eyes of a user. Such electronic devices often include virtual or augmented reality headsets with displays having optical elements that allow users to view the displays. If care is not taken, components used to display images can be bulky and might not exhibit desired levels of optical performance. For example, scattered light can increase background noise and limit contrast associated with sensing operations performed by the displays.

### SUMMARY

An electronic device may have a display system for providing image light to an eye box. The display system may include a waveguide. A projector may generate image light. An input coupler may couple the image light into the waveguide. An output coupler may couple the image light out of the waveguide and towards the eye box.

The display system may include an optical emitter that emits infrared light. A first optical coupler may couple the infrared light into the waveguide. A second optical coupler may couple the infrared light out of the waveguide and towards the eye box. The infrared light may reflect off an eye in the eye box as reflected light. The second optical coupler may couple the reflected light into the waveguide. The first optical coupler may couple the reflected light out of the waveguide and towards an infrared camera. The infrared camera may generate sensor data based on the reflected light. Control circuitry may perform gaze tracking operations based on the sensor data.

The display system may sequentially illuminate different regions of the eye with the infrared light at different times. This may minimize infrared light scattering, which minimizes background generation and maximizes signal-to-noise ratio in the sensor data generated by the infrared camera. To illuminate the different regions, the display system may include a scanning mirror that couples the light into the waveguide at different angles at different times, the optical emitter may include an array of light sources with include sets (e.g., columns) of light sources that are sequentially activated, and/or the optical emitter may emit light at different wavelengths that are directed in different directions by diffractive gratings.

### BRIEF DESCRIPTION OF THE DRAWINGS

FIG. 1 is a diagram of an illustrative system having a display with an optical sensor in accordance with some embodiments.

FIG. 2 is a top view of an illustrative optical system for a display having a waveguide with optical couplers in accordance with some embodiments.

FIG. 3 is a top view of an illustrative optical system having an optical sensor and a scanning mirror for sequentially illuminating different portions of an eye box in accordance with some embodiments.

FIG. 4 is a front view of an illustrative array of light sources in an optical sensor that can be selectively activated to sequentially illuminate different portions of an eye box in accordance with some embodiments.

FIG. 5 is a top view of an illustrative optical system showing how an illustrative array of the type shown in FIG. 4 may couple emitted light into a waveguide in accordance with some embodiments.

FIG. 6 is a top view of an illustrative optical coupler having constant pitch holograms for diffracting light of different wavelengths towards different portions of an eye box in accordance with some embodiments.

FIG. 7 is a top view of an illustrative surface relief grating that couples different wavelengths of light into a waveguide at different angles for illuminating different portions of an eye box in accordance with some embodiments.

FIG. 8 is a flow chart of illustrative operations involved in performing optical sensing operations by sequentially illuminating different portions of an eye box in accordance with some embodiments.

### DETAILED DESCRIPTION

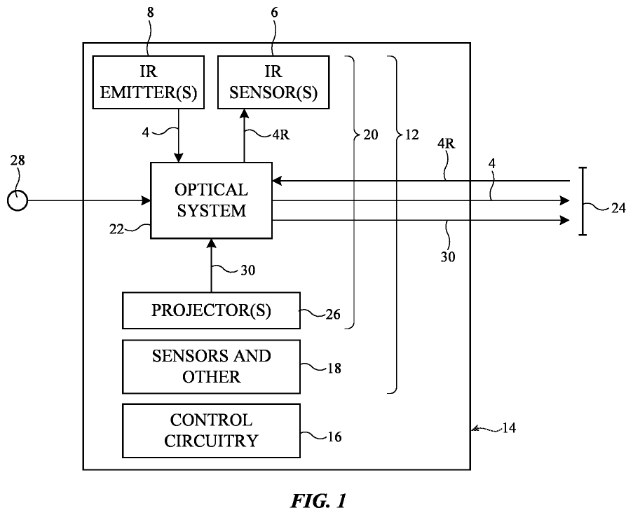

System 10 of FIG. 1 may be an electronic device such as a head-mounted device having one or more displays. The displays in system 10 may include near-eye displays 20 mounted within support structure (housing) 14. Support structure 14 may have the shape of a pair of eyeglasses or goggles (e.g., supporting frames), may form a housing having a helmet shape, or may have other configurations to help in mounting and securing the components of near-eye displays 20 on the head or near the eye of a user. Near-eye displays 20 may include one or more display projectors such as projectors 26 (sometimes referred to herein as display modules 26) and one or more optical systems such as optical systems 22. Projectors 26 may be mounted in a support structure such as support structure 14. Each projector 26 may emit image light 30 that is redirected towards a user's eyes at eye box 24 using an associated one of optical systems 22. Image light 30 may be, for example, light that contains and/or represents something viewable such as a scene or object (e.g., as modulated onto the image light using the image data provided by the control circuitry to the display module).

The operation of system 10 may be controlled using control circuitry 16. Control circuitry 16 may include storage and processing circuitry for controlling the operation of system 10. Control circuitry 16 may include storage such as hard disk drive storage, nonvolatile memory (e.g., electrically-programmable-read-only memory configured to form a solid state drive), volatile memory (e.g., static or dynamic random-access-memory), etc. Processing circuitry in control circuitry 16 may include one or more processors (e.g., microprocessors, microcontrollers, digital signal processors, baseband processors, etc.), power management units, audio chips, graphics processing units, application specific integrated circuits, and other integrated circuits. Software code may be stored on storage in control circuitry 16 and run on processing circuitry in control circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted device 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include sensors and other components 18 (e.g., image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.).

Projectors 26 may include liquid crystal displays, organic light-emitting diode displays, laser-based displays, or displays of other types. Projectors 26 may include light sources, emissive display panels, transmissive display panels that are illuminated with illumination light from light sources to produce image light, reflective display panels such as digital micromirror display (DMD) panels and/or liquid crystal on silicon (LCOS) display panels that are illuminated with illumination light from light sources to produce image light 30, etc.

Optical systems 22 may form lenses that allow a viewer (see, e.g., a viewer's eyes at eye box 24) to view images on display(s) 20. There may be two optical systems 22 (e.g., for forming left and right lenses) associated with respective left and right eyes of the user. A single display 20 may produce images for both eyes or a pair of displays 20 may be used to display images. In configurations with multiple displays (e.g., left and right eye displays), the focal length and positions of the lenses formed by system 22 may be selected so that any gap present between the displays will not be visible to a user (e.g., so that the images of the left and right displays overlap or merge seamlessly).

If desired, optical system 22 may contain components (e.g., an optical combiner, etc.) to allow real-world light (sometimes referred to as world light) from real-world (external) objects such as object 28 to be combined optically with virtual (computer-generated) images such as virtual images in image light 30. In this type of system, which is sometimes referred to as an augmented reality system, a user of system 10 may view both real-world content (e.g., world light from object 28) and computer-generated content that is overlaid on top of the real-world content. Camera-based augmented reality systems may also be used in device 10 (e.g., in an arrangement in which a camera captures real-world images of object 28 and this content is digitally merged with virtual content at optical system 22).

System 10 may, if desired, include wireless circuitry and/or other circuitry to support communications with a computer or other external equipment (e.g., a computer that supplies display 20 with image content). During operation, control circuitry 16 may supply image content to display 20. The content may be remotely received (e.g., from a computer or other content source coupled to system 10) and/or may be generated by control circuitry 16 (e.g., text, other computer-generated content, etc.). The content that is supplied to display 20 by control circuitry 16 may be viewed by a viewer at eye box 24.

If desired, system 10 may include an optical sensor. The optical sensor may be used to gather optical sensor data associated with a user's eyes at eye box 24. The optical sensor may, for example, be a gaze tracking sensor that gathers optical sensor data such as gaze image data (gaze tracking image data or gaze tracking sensor data) from a user's eye at eye box 24. Control circuitry 16 may process the optical sensor data to identify and track the direction of the user's gaze in real time. Control circuitry 16 may perform any desired operations based on the tracked direction of the user's gaze over time.

As shown in FIG. 1, the optical sensor (gaze tracking sensor) may include one or more optical emitters such as infrared emitter(s) 8 and one or more optical receivers (sensors) such as infrared sensor(s) 6 (sometimes referred to herein as optical sensor 6). Infrared emitter(s) 8 may include one or more light sources that emit sensing light such as light 4. Light 4 may be used for performing optical sensing on/at eye box 24 (e.g., gaze tracking) rather than conveying pixels of image data such as in image light 30. Light 4 may include infrared light. The infrared light may be at infrared (IR) wavelengths and/or near-infrared (NIR) wavelengths (e.g., any desired wavelengths from around 700 nm to around 1 mm). Light 4 may additionally or alternatively include wavelengths less than 700 nm if desired. Light 4 may sometimes be referred to herein as sensor light 4.

Infrared emitter(s) 8 may direct light 4 towards optical system 22. Optical system 22 may direct the light 4 emitted by infrared emitter(s) 8 towards eye box 24. Light 4 may enter the user's eye at eye box 24 and may reflect off portions (regions) of the user's eye such as the retina as reflected light 4R (sometimes referred to herein as reflected sensor light 4R). Optical system 22 may receive reflected light 4R and may direct reflected light 4R towards infrared sensor(s) 6. Infrared sensor(s) 6 may receive reflected light 4R from optical system 22 and may gather (e.g., generate, measure, sense, produce, etc.) optical sensor data in response to the received reflected light 4R. Infrared sensor(s) 6 may include an image sensor or camera (e.g., an infrared image sensor or camera), for example. Infrared sensor(s) 6 may include, for example, one or more image sensor pixels (e.g., arrays of image sensor pixels). The optical sensor data may include image sensor data (e.g., image data, infrared image data, one or more images, etc.). Infrared image sensor(s) 6 may pass the optical sensor data to control circuitry 16 for further processing.

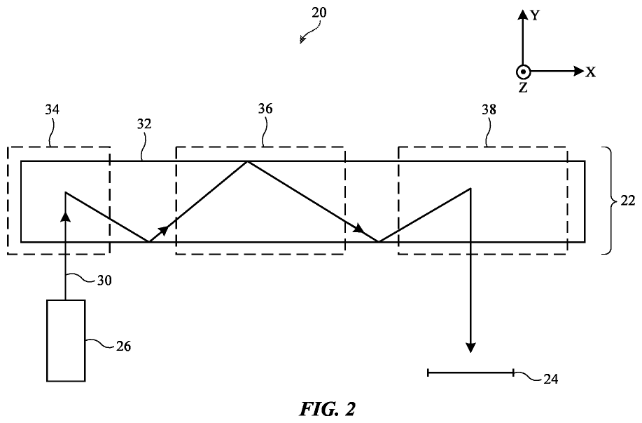

FIG. 2 is a top view of an illustrative display 20 that may be used in system 10 of FIG. 1. As shown in FIG. 2, display 20 may include a projector such as projector 26 and an optical system such as optical system 22. Optical system 22 may include optical elements such as one or more waveguides 32. Waveguide 32 may include one or more stacked substrates (e.g., stacked planar and/or curved layers sometimes referred to herein as waveguide substrates) of optically transparent material such as plastic, polymer, glass, etc.

If desired, waveguide 32 may also include one or more layers of holographic recording media (sometimes referred to herein as holographic media, grating media, or diffraction grating media) on which one or more diffractive gratings are recorded (e.g., holographic phase gratings, sometimes referred to herein as holograms, surface relief gratings, etc.). A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to create a three-dimensional reconstruction of the holographic recording. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of holographic medium if desired. The holographic phase gratings may be, for example, volume holograms or thin-film holograms in the grating medium. The grating medium may include photopolymers, gelatin such as dichromated gelatin, silver halides, holographic polymer dispersed liquid crystal, or other suitable holographic media.

Diffractive gratings on waveguide 32 may include holographic phase gratings such as volume holograms or thin-film holograms, meta-gratings, or any other desired diffractive grating structures. The diffractive gratings on waveguide 32 may also include surface relief gratings (SRGs) formed on one or more surfaces of the substrates in waveguide 32 (e.g., as modulations in thickness of a SRG medium layer), gratings formed from patterns of metal structures, etc. The diffractive gratings may, for example, include multiple multiplexed gratings (e.g., holograms) that at least partially overlap within the same volume of grating medium (e.g., for diffracting different colors of light and/or light from a range of different input angles at one or more corresponding output angles). Other light redirecting elements such as louvered mirrors may be used in place of diffractive gratings in waveguide 32 if desired.

As shown in FIG. 2, projector 26 may generate (e.g., produce and emit) image light 30 associated with image content to be displayed to eye box 24 (e.g., image light 30 may convey a series of image frames for display at eye box 24). Image light 30 may be collimated using a collimating lens in projector 26 if desired. Optical system 22 may be used to present image light 30 output from projector 26 to eye box 24. If desired, projector 26 may be mounted within support structure 14 of FIG. 1 while optical system 22 may be mounted between portions of support structure 14 (e.g., to form a lens that aligns with eye box 24). Other mounting arrangements may be used, if desired.

Optical system 22 may include one or more optical couplers (e.g., light redirecting elements) such as input coupler 34, cross-coupler 36, and output coupler 38. In the example of FIG. 2, input coupler 34, cross-coupler 36, and output coupler 38 are formed at or on waveguide 32. Input coupler 34, cross-coupler 36, and/or output coupler 38 may be completely embedded within the substrate layers of waveguide 32, may be partially embedded within the substrate layers of waveguide 32, may be mounted to waveguide 32 (e.g., mounted to an exterior surface of waveguide 32), etc.

Waveguide 32 may guide image light 30 down its length via total internal reflection. Input coupler 34 may be configured to couple image light 30 from projector 26 into waveguide 32 (e.g., within a total-internal reflection (TIR) range of the waveguide within which light propagates down the waveguide via TIR), whereas output coupler 38 may be configured to couple image light 30 from within waveguide 32 (e.g., propagating within the TIR range) to the exterior of waveguide 32 and towards eye box 24 (e.g., at angles outside of the TIR range). Input coupler 34 may include an input coupling prism, an edge or face of waveguide 32, a lens, a steering minor or liquid crystal steering element, diffractive grating structures (e.g., volume holograms, SRGs, etc.), partially reflective structures (e.g., louvered mirrors), or any other desired input coupling elements.

As an example, projector 26 may emit image light 30 in direction +Y towards optical system 22. When image light 30 strikes input coupler 34, input coupler 34 may redirect image light 30 so that the light propagates within waveguide 32 via total internal reflection towards output coupler 38 (e.g., in direction +X within the TIR range of waveguide 32). When image light 30 strikes output coupler 38, output coupler 38 may redirect image light 30 out of waveguide 32 towards eye box 24 (e.g., back along the Y-axis). In implementations where cross-coupler 36 is formed on waveguide 32, cross-coupler 36 may redirect image light 30 in one or more directions as it propagates down the length of waveguide 32 (e.g., towards output coupler 38 from a direction of propagation as coupled into the waveguide by the input coupler). In redirecting image light 30, cross-coupler 36 may also perform pupil expansion on image light 30 in one or more directions. In expanding pupils of the image light, cross-coupler 36 may, for example, help to reduce the vertical size of waveguide 32 (e.g., in the Z direction) relative to implementations where cross-coupler 36 is omitted. Cross-coupler 36 may therefore sometimes also be referred to herein as pupil expander 36 or optical expander 36. If desired, output coupler 38 may also expand image light 30 upon coupling the image light out of waveguide 32.

Input coupler 34, cross-coupler 36, and/or output coupler 38 may be based on reflective and refractive optics or may be based on diffractive (e.g., holographic) optics. In arrangements where couplers 34, 36, and 38 are formed from reflective and refractive optics, couplers 34, 36, and 38 may include one or more reflectors (e.g., an array of micromirrors, partial mirrors, louvered mirrors, or other reflectors). In arrangements where couplers 34, 36, and 38 are based on diffractive optics, couplers 34, 36, and 38 may include diffractive gratings (e.g., volume holograms, surface relief gratings, etc.).

The example of FIG. 2 is merely illustrative. Optical system 22 may include multiple waveguides that are laterally and/or vertically stacked with respect to each other. Each waveguide may include one, two, all, or none of couplers 34, 36, and 38. Waveguide 32 may be at least partially curved or bent if desired. One or more of couplers 34, 36, and 38 may be omitted. If desired, optical system 22 may include a single optical coupler that performs the operations of both cross-coupler 36 and output coupler 38 (sometimes referred to herein as an interleaved coupler, a diamond coupler, or a diamond expander) or cross-coupler 36 may be separate from output coupler 38.

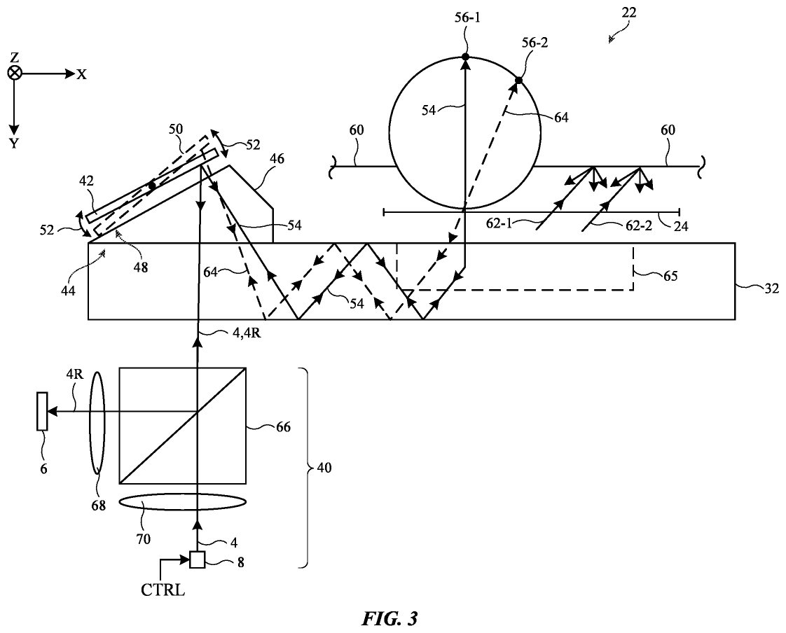

The operation of optical system 22 on image light 30 is shown in FIG. 2. Optical system 22 may also direct light 4 from infrared emitter(s) 8 towards eye box 24 and may direct reflected light 4R from eye box 24 towards infrared sensor(s) 6 (FIG. 1). FIG. 3 is a top view showing one example of how optical system 22 may direct light 4 from infrared emitter(s) 8 towards eye box 24 and may direct reflected light 4R from eye box 24 towards infrared sensor(s) 6 (FIG. 1). In the example of FIG. 3, image light 30 and the couplers that operate on image light are not shown for the sake of clarity.

As shown in FIG. 3, infrared emitter(s) 8 and infrared sensor(s) 6 may be integrated or disposed in a gaze tracking sensor 40 (sometimes referred to herein as gaze tracking system 40 or optical sensor 40). Gaze tracking sensor 40 may include optics such as optics 66, collimating lens 68, and collimating lens 70. Infrared emitter(s) 8 may include one or more light sources that emit light 4. Infrared emitter(s) 8 may receive control signals CTRL (e.g., from control circuitry 16 of FIG. 1) that control how and when infrared emitter(s) 8 emit light 4. Collimating lens 70 may direct light 4 towards optics 66. Optics 66 may include one or more optical wedges, prisms, lenses, beam splitters (e.g., partial reflectors), polarizing beam splitters, or other optical components for redirecting light 4 and reflected light 4R in different directions. Optics 66 may direct light 4 towards optical system 22. Gaze tracking sensor 40 may also receive reflected light 4R from optical system 22. Optics 66 may direct reflected light 4R towards collimating lens 68, which directs reflected light 4R to infrared sensor(s) 6.

Optical system 22 may include at least a first optical coupler 44 and a second optical coupler 65 for use in performing optical sensing for gaze tracking sensor 40 (e.g., for redirecting light 4 and reflected light 4R). Optical couplers 44 and 65 may be disposed at, on, or within waveguide 32. Optical coupler 44 may also redirect image light 30 produced by projector 26 (e.g., optical coupler 44 may also form input coupler 34, cross-coupler 36, and/or output coupler 38 of FIG. 2) or may not redirect image light 30. Optical coupler 65 may also redirect image light 30 produced by projector 26 (e.g., optical coupler 65 may also form input coupler 34, cross-coupler 36, and/or output coupler 38 of FIG. 2) or may not redirect image light 30.

When a user is wearing or using system 10 (FIG. 1), the user's eye 58 may be located in or overlapping eye box 24. Other portions of the user's body such as skin 60 may also overlap eye box 24 or other portions of waveguide 32 around eye box 24. During optical sensing at eye box 24 (e.g., gaze tracking operations), optical system 22 may direct light 4 into eye 58 to illuminate one or more regions 56 on the user's eye (e.g., on the user's retina). Light 4 may reflect off of the one or more regions 56 as reflected light 4R. Optical system 22 may direct reflected light 4R towards gaze tracking sensor 40. Light 4 and reflected light 4R may propagate along waveguide 32 via total internal reflection (TIR).

Optical coupler 44 may form an input coupler for the light 4 emitted by gaze tracking sensor 40. Optical coupler 44 may therefore couple light 4 incident upon optical system 22 from incident angles outside the TIR range of waveguide 32 into waveguide 32 (e.g., at output angles within the TIR range of the waveguide). Optical coupler 44 may also form an output coupler for the reflected light 4R received by optical system 22 after reflection off eye 58. Optical coupler 44 may therefore couple reflected light 4R incident upon optical coupler 44 at incident angles within the TIR range of waveguide 32 (e.g., after propagating along waveguide 32 via TIR) out of waveguide 32 and towards gaze tracking sensor 40 (e.g., at output angles outside the TIR range of waveguide 32).

Optical coupler 65 may form an output coupler for the light 4 propagating along waveguide 32 via TIR. Optical coupler 65 may therefore couple light 4 incident upon optical coupler 65 from incident angles within the TIR range of waveguide 32 out of waveguide 32 and towards eye box 24 (e.g., at output angles outside the TIR range of the waveguide). Optical coupler 65 may also form an input coupler for the reflected light 4R received by optical system 22 after reflection off eye 58. Optical coupler 65 may therefore couple reflected light 4R incident upon optical coupler 65 at incident angles outside the TIR range of waveguide 32 into waveguide 32 (e.g., at output angles within the TIR range of waveguide 32).

Optical coupler 44 and optical coupler 65 may each include prisms, mirrors, partial reflectors (e.g., louvered mirrors), volume holograms, surface relief gratings (SRGs), meta-gratings, waveguide facets, lenses, and/or any other desired optical coupling structures. Optical coupler 44 may include, for example, a prism such as prism 46 whereas optical coupler 65 includes one or more SRGs or volume holograms.

In the example of FIG. 3, prism 46 is mounted to the side (lateral surface) of waveguide 32 facing eye box 24 whereas gaze tracking sensor 40 is mounted at/facing the side of waveguide 32 opposite eye box 24 (e.g., a world-facing side of the waveguide). Prism 46 is a reflective coupling prism in this example (e.g., prism 46 has a reflective face 48 that reflects light 4 into waveguide 32 and that reflects reflected light 4R out of waveguide 32). This is merely illustrative. If desired, both prism 46 and gaze tracking sensor 40 may be disposed at the side of waveguide 32 facing eye box 24 or both prism 46 and gaze tracking sensor 40 may be disposed at the world-facing side of waveguide 32. In these examples, prism 46 may be a transmissive coupling prism if desired. In other implementations, prism 46 may be mounted to the world-facing side (lateral surface) of waveguide 32 opposite eye box 24 whereas gaze tracking sensor 40 is mounted at the side of waveguide 32 facing eye box 24.

In general, it may be desirable for gaze tracking sensor 40 to gather optical sensor data (images) of multiple different regions (areas or portions) 56 of eye 58 while performing optical sensing at eye box 24. The different regions may, for example, correspond to different physiological features on the retina of eye 58. These physiological features may help control circuitry 16 (FIG. 1) to identify and track the gaze direction of eye 58 over time (e.g., by performing feature a detection operation on the physiological features to generate a vector oriented in the direction of the user's gaze at eye box 24). For example, more regions 56 (and thus imaged physiological features) may increase the precision and/or accuracy with which gaze tracking is performed relative to fewer regions 56.

In some implementations, gaze tracking sensor 40 illuminates each of the multiple regions 56 at the same time and thus receives reflected light 4R from each of the multiple regions 56 at the same time. Each region 56 may be illuminated by a different respective optical mode of the system. For example, the system may include at least a first optical mode (propagation direction) that illuminates a first region 56-1 (as shown by arrow 54) and a second optical mode (propagation direction) that simultaneously illuminates a second region 56-2 (as shown by arrow 64).

However, not all of the light redirected by optical coupler 65 is coupled into or out of eye 58. At least some of the light from each optical mode will leak in other directions, such as towards skin 60, which will undesirably reflect or scatter the light in different directions (as optical scattering 62). For example, as shown in FIG. 3, the first optical mode may produce first optical scattering 62-1 off skin 60 and the second optical mode may produce second optical scattering 62-2 off skin 60. Simultaneously activating both the first and second optical modes to simultaneously illuminate both region 56-1 and region 56-2 may produce an excessive amount of optical scattering off skin 60 (e.g., both optical scattering 62-1 and 62-2 may be present at the same time). Additional simultaneous optical modes that illuminate additional regions 56 on eye 58 will only further increase the amount of concurrent scattering off skin 60 (e.g., the amount of background scatter increases linearly with the number of simultaneously active optical modes). Excessive scattering off skin 60 may introduce an excessive amount of stray light 4 and stray reflected light 4R in the system, which can increase the amount of noise in the optical sensor data gathered by infrared sensor(s) 6, thereby reducing the contrast of the desired images of regions 56 gathered by infrared sensor(s) 6 and making it more difficult for control circuitry 16 to perform feature detection to track the direction of the user's gaze.

To mitigate these issues, gaze tracking sensor 40 and optical system 22 may sequentially illuminate each of the multiple different regions 56 on eye 58 in series (e.g., at different times in a time-division duplexed manner). Optical system 22 and/or gaze tracking sensor 40 may, for example, include an adjustable or tunable optical component that allows gaze tracking sensor 40 and optical system 22 to sequentially illuminate each of the multiple different regions 56 on eye 58 in series. The adjustable or tunable optical component may include a scanning mirror, a selectively adjustable array of light sources, or light source(s) having variable wavelengths, as examples.

FIG. 3 shows an example in which the adjustable or tunable component is beam steering element such as a scanning mirror (e.g., a reflective beam steering element). As shown in FIG. 3, optical system 22 may include a scanning mirror such as scanning mirror 42. Scanning mirror 42 may receive electrical signals (e.g., control signals from control circuitry 16 of FIG. 1) that control scanning mirror 42 to rotate about one or more axes. Scanning mirror 42 may be a piezoelectric scanning mirror or a micro-electromechanical systems (MEMs) mirror, as examples. In the example of FIG. 3, scanning mirror 42 is a one-dimensional scanning mirror that rotates about a single axis, as shown by arrows 52.

Scanning mirror 42 may overlap reflective face (surface) 48 of prism 46. Scanning mirror 42 may receive light 4 from gaze tracking sensor 40 through waveguide 32 and prism 46 and may reflect light 4 into waveguide 32 through prism 46. Similarly, scanning mirror 42 may receive reflected light 4R from waveguide 32 through prism 46 and may reflect the reflected light 4R through prism 46 and waveguide 32 towards gaze tracking sensor 40.

Scanning mirror 42 may be adjustable between multiple different orientations. In each orientation, scanning mirror 42 may reflect light 4 towards and may receive reflected light 4R from different regions 56 of eye 58. For example, as shown in FIG. 3, when scanning mirror 42 has a first orientation (angle), light 4 and reflected light 4R may pass between scanning mirror 42 and region 56-1 on eye 58, as shown by optical path (arrows) 54. When scanning mirror 42 has a second orientation (angle) such as orientation 50, light 4 and reflected light 4R may pass between scanning mirror 42 and region 56-2 on eye 58, as shown by dashed optical path (arrows) 64.

More particularly, in the first orientation, scanning mirror 42 may reflect light 4 at a first angle into waveguide 32, which propagates light 4 towards optical coupler 65. Optical coupler 65 may couple (diffract) light 4 out of waveguide 32 at the same angles at which optical coupler 65 couples (diffracts) reflected light 4R into waveguide 32 (e.g., the Bragg-matching condition of optical coupler 65 may be such that optical coupler 65 directs light 4 onto an angle that is 180 degrees opposite the angle at which it receives reflected light 4R and directs reflected light 4R onto the angle that is 180 degrees opposite the angle at which it receives light 4). Optical coupler 65 therefore receives light 4 and couples (e.g., diffracts) light 4 out of waveguide 32 and towards region 56-1 of eye 58. Light 4 reflects off region 56-1 towards optical coupler as reflected light 4R. Optical coupler 65 couples reflected light 4R into waveguide 32 such that reflected light 4R propagates along waveguide 32 and is received at scanning minor 42 (in the first orientation) on-axis with the light 4 reflected off scanning minor 42 (in the first orientation).

In the second orientation 50, scanning minor 42 may reflect light 4 at a second angle into waveguide 32, which propagates light 4 towards optical coupler 65. Optical coupler 65 receives light 4 and couples (e.g., diffracts) light 4 out of waveguide 32 and towards region 56-2 of eye 58. Light 4 reflects off region 56-2 towards optical coupler 65 as reflected light 4R. Optical coupler 65 couples reflected light 4R into waveguide 32 such that reflected light 4R propagates along waveguide 32 and is received at scanning mirror 42 (in the second orientation) on-axis with the light 4 reflected off scanning mirror 42 (in the second orientation).

In the example of FIG. 3, only two regions 56 are illuminated and scanning mirror 42 is shown as having two orientations for the sake of clarity. In general, gaze tracking sensor 40 and optical system 22 may illuminate any desired number N of region 56 on eye 58 (e.g., scanning mirror 42 may have at least N different orientations and the system may have at least N optical modes). By rapidly and sequentially rotating scanning mirror 42 between each of the N orientations, optical sensor(s) 6 may gather optical sensor data (images) of each of the N regions on eye 58 for performing gaze tracking operations. In the example of FIG. 3, light is coupled into and out of the waveguide using a reflective beam steering component (e.g., scanning mirror 42). In other implementations, a transmissive beam steering component may be used to couple light 4 into and to couple reflected light 4R out of waveguide 32 (e.g., may replace scanning mirror 42 and prism 46). The transmissive beam steering component may include a deformable wedge and/or an acousto-optic modulator (AOM) mounted at or to the lateral surface of waveguide 32 that faces gaze tracking sensor 40, for example.

In the example of FIG. 3, infrared emitter(s) 8 may include a single light source if desired. The light source may include a collimated vertical-cavity surface-emitting laser (VCSEL), light-emitting diode (LED), super-luminescent diode (SLD), and/or other light sources. If desired, a one-dimensional (1D) diffuser may be optically interposed between the light source and lens 70 to spread light 4 evenly along a column perpendicular to the direction of the 1D rotation of scanning minor 42. When combined with the 1D rotation of scanning mirror 42, this may allow gaze tracking sensor 40 to produce or paint a two-dimensional (2D) image multiple across regions 56 of eye 58. In other implementations, a 2D scanning mirror may be used to address angles that are into the plane of the page.

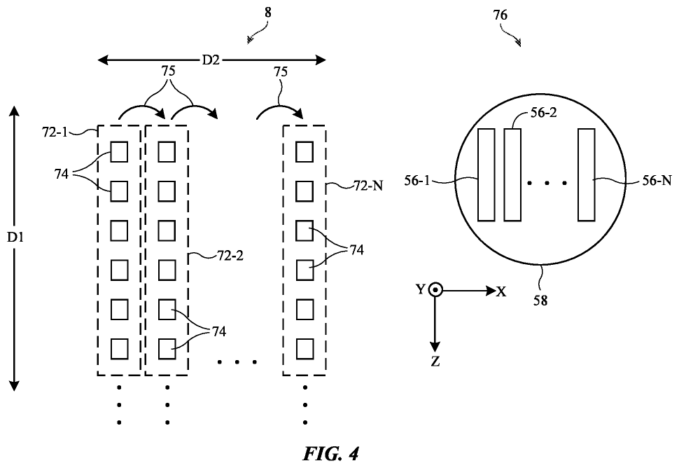

If desired, scanning mirror 42 may be omitted and the adjustable or tunable optical component that allows gaze tracking sensor 40 and optical system 22 to sequentially illuminate each of the multiple different regions 56 may include a selectively adjustable array of light sources in infrared emitter(s) 8. FIG. 4 is a diagram showing how infrared emitter(s) 8 may include a selectively adjustable array of light sources.

As shown in FIG. 4, infrared emitter(s) 8 may include a 2D array of light sources 74 that emit light 4. Light sources 74 may include VCSELs, for example. Light sources 74 may be arranged in any desired pattern such as a rectangular grid of rows and columns. There may be N sets 72 of light sources 74 (e.g., a first set 72-1, a second set 72-2, an Nth set 72-N, etc.). Control signals CTRL (FIG. 3) may sequentially and selectively illuminate different sets 72 of light sources 74 at different times, as shown by arrows 75.

For example, control signals CTRL may first activate each light source 74 in the first set (e.g., column) 72-1 of light sources 74 so set 72-1 emits light 4 while the other sets 72 of light sources 74 are inactive (e.g., do not emit light 4). Control signals CTRL may then activate each light source 74 in the second set (e.g., column) 72-2 of light sources 74 so set 72-2 emits light 4 while the other sets 72 of light sources 74 are inactive. Different sets 72 may be illuminated in series in this way until the Nth set 72-N is illuminated.

When sets 72 are arranged in the rectangular grid pattern of FIG. 4, light sources 74 are arranged in a 2D array having a first dimension D1 and a second dimension D2. Light sources 74 are concurrently activated along first dimension D1 and sequentially illuminated along dimension D2. Each set 72 of light sources 74 may direct light towards optical coupler 44 on waveguide 32 (FIG. 3) in a slightly different propagation direction (in a different optical mode of the system) due to the lateral separation of sets 72 and/or the configuration of the optics between infrared emitter(s) 8 and waveguide 32. Each set 72 of light sources 74 may therefore illuminate a different respective region 56 of eye 58, as shown in portion 76 of FIG. 4 (e.g., set 72-1 may illuminate region 56-1, set 72-2 may illuminate region 56-2, set 72-N may illuminate region 56-N, etc.).

Each set 72 may, for example, illuminate a different rectangular (column-shaped or 1D) region of the retina and scanning (selectively activating) each set 72 in series may effectively produce or paint a two-dimensional (2D) patch of illumination across each of the multiple regions 56 of eye 58. If desired, one or more of the axes of the 2D array of light sources 74 (e.g., the directions of the rows or columns of light sources 74) may be tilted with respect to one or more of the axes of system 10. While infrared sensor(s) 6 of FIG. 3 need only include a 1D image sensor in implementations where a 1D scanning minor 42 is used, infrared sensor(s) 6 may include a 2D image sensor in implementations where infrared emitter(s) 8 include a 2D array of light sources 74.

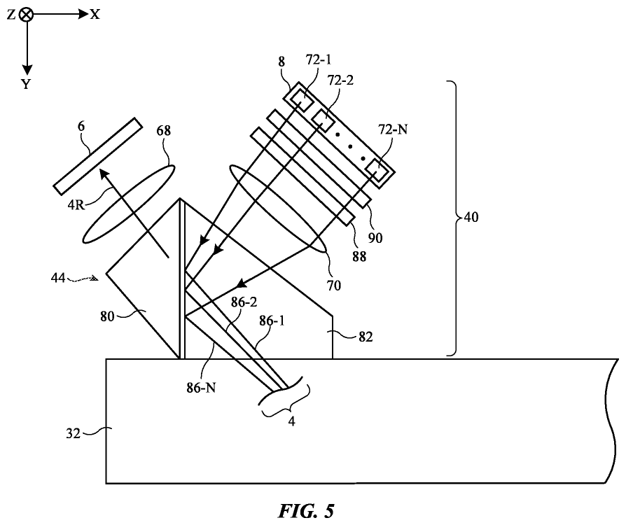

FIG. 5 is a diagram showing how the 2D array of light sources 74 of FIG. 4 may couple light 4 into waveguide 32. As shown in FIG. 5, optical coupler 44 may include one or more optical wedges (e.g., prisms) such as optical wedges 80 and 82 mounted to a surface of waveguide 32. A beam splitter (e.g., polarizing beam splitter) such as beam splitter 80 may be disposed between optical wedge 80 and optical wedge 82. Infrared emitter(s) 8 may include N sets 72 of optical sources 74 (FIG. 4).

One or more optical diffusers such as at least a first diffuser 90 and a second diffuser 88 may be optically interposed between collimating lens 70 and infrared emitter(s) 8. First diffuser 90 may be optically interposed between second diffuser 88 and infrared emitter(s) 8. Second diffuser 88 may be optically interposed between collimating lens 70 and first diffuser 90. First diffuser 90 may be, for example, a 2D diffuser that diffuses the light 4 emitted by infrared emitter(s) 8 along both the first dimension D1 and the second dimension D2 of the array (FIG. 4). Second diffuser 90 may be, for example, a 1D diffuser that diffuses the light 4 emitted by infrared emitter(s) 8 along the unscanned dimension of the array (e.g., dimension D1 of FIG. 4). This may help to direct light 4 towards beam splitter 84 while filling the gaps between sets 72 and between light sources 74 with light 4 (e.g., where a VCSEL column is translated to a beam with continuous, spatially-uniform broad angular extent).

As shown in FIG. 5, the light 4 produced by each set 72 of light sources 74 may reflect off beam splitter 80 and may be coupled into waveguide 32 through optical wedge 82 in a different respective propagation direction, as shown by arrows 86 (e.g., the light 4 produced by set 72-1 may be coupled into waveguide 32 in the direction of arrow 86-1, the light 4 produced by set 72-2 may be coupled into waveguide 32 in the direction of arrow 86-2, the light 4 produced by set 72-N may be coupled into waveguide 32 in the direction of arrow 86-N, etc.). This may configure the light 4 produced by each set 72 to illuminate a different respective region 56 of eye 58 (FIG. 4). The reflected light 4R from regions 56 of eye 58 may be coupled out of waveguide 32 through optical wedge 82, beam splitter 84, and optical wedge 80 towards infrared sensor(s) 6 (e.g., a 2D camera). Beam splitter 84 may, for example, be a reflective polarizer that reflects light of a first linear polarization while transmitting light of a second linear polarization orthogonal to the first linear polarization. A linear polarizer (not shown) may be optically interposed between infrared emitter(s) 8 and prism 82 and may transmit light 4 towards prism 82 with the first linear polarization. Beam splitter 84 may thereby reflected light 4 into waveguide 32. Beam splitter 84 may transmit, towards infrared sensor(s) 6, the portion of the incident reflected light 4R having the second linear polarization. If desired, a crossed polarizer may be optically interposed between beam splitter 84 and infrared sensor(s) 6 to reject unwanted polarizations of reflected light 4R.

If desired, the adjustable or tunable optical component that allows gaze tracking sensor and optical system 22 to sequentially illuminate each of the multiple different regions 56 may include a light source in infrared emitter(s) 8 that is adjusted to produce light 4 at different wavelengths at different times. For example, infrared emitter(s) 8 (FIG. 3) may include one or more light sources (e.g., a tunable VCSEL). The light source(s) may receive control signals CTRL that control the light source(s) to emit light 4 at a selected wavelength that can be tuned or adjusted over time. Each wavelength may be used to illuminate a different respective region 56 of eye 58. As such, control signals CTRL may control the light source(s) to sequentially emit light 4 at each of the different wavelengths.

In these implementations, if care is not taken, light 4 and reflected light 4R will follow the same optical mode of propagation at each of the wavelengths. Optical system 22 may therefore include diffractive gratings that direct light 4 at different wavelengths to different regions 56 on eye 58 (and that direct reflected light 4 at different wavelengths from different regions 56 towards infrared sensor(s) 6). The diffractive gratings may include volume holograms in optical coupler 65, as one example. The volume holograms may be constant-pitch volume holograms if desired.

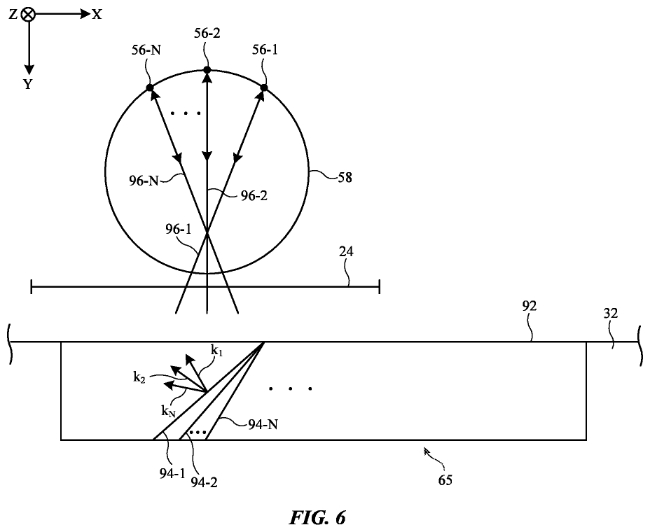

FIG. 6 is a diagram showing how optical coupler 65 may include volume holograms for illuminating different regions 56 of eye 58 with different wavelengths of light 4. As shown in FIG. 6, optical coupler 65 may include a set of volume holograms 94 in a grating medium (holographic recording medium) 92 on waveguide 32. Each of the volume holograms 94 in optical coupler 65 may be overlapping or superimposed within the same volume of grating medium 92.

Each volume hologram 94 may be defined by a corresponding grating vector k. The grating vector k may have a direction in three-dimensional space that is normal to the plane of the fringes (e.g., lines of constant refractive index) of the hologram. The volume holograms 94 in optical coupler 65 may be constant-pitch volume holograms that have the same pitch (e.g., the same periodicity of fringes within substrate 65) but with different orientations.

Each hologram 94 may diffract a different respective wavelength of light 4 incident from the same direction onto a different respective one of the N regions 56 on eye 58. For example, optical coupler 65 may include at least a first volume hologram 94-1 defined by a first grating vector k₁ and having fringes at a first orientation, a second volume hologram 94-2 defined by a second grating vector k₂ and having fringes at a second orientation different from the first orientation, and an Nth volume hologram 94-N defined by an Nth grating vector k_{N} and having fringes at an Nth orientation that is different from the first and second orientations. First volume hologram 94-1 may direct light 4 of a first wavelength and incident at a given incident angle towards region 56-1 on eye 58. Second volume hologram 94-2 may direct light 4 of a second wavelength and incident at the given incident angle towards region 56-2 on eye 58. Nth volume hologram 94-N may direct light 4 of an Nth wavelength and incident at the given incident angle towards region 56-N on eye 58. The volume holograms may conversely direct reflected light 4R from each of the regions onto the same output angle towards infrared sensor(s) 6 (FIG. 1), which may be a 1D camera in these implementations (for example).

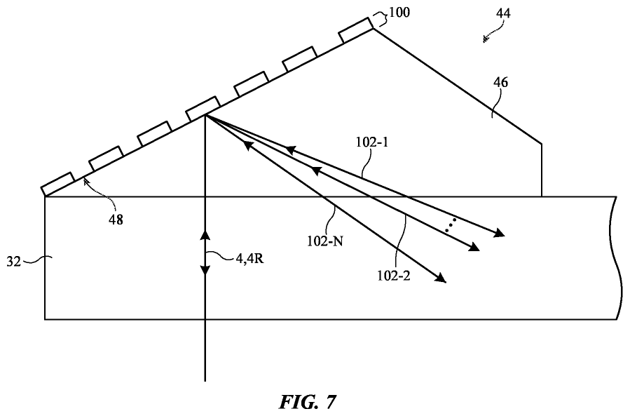

By sequentially controlling the tunable light source in infrared emitter(s) 8, different regions 56 may be illuminated with light 4 at different times. The example of FIG. 6 in which the diffractive gratings that direct different wavelengths of light 4 in different directions include volume holograms is merely illustrative. If desired, the diffractive gratings may include a surface relief grating (SRG). FIG. 7 is a diagram showing how the diffractive gratings that direct different wavelengths of light 4 in different directions may include an SRG.

As shown in FIG. 7, an SRG such as SRG 100 may be disposed or layered onto reflective face 48 of prism 46. SRG 100 may receive light 4 from gaze tracking sensor 40 (FIG. 3) through waveguide 32 and prism 46. SRG 100 may diffract different wavelengths of light 4 in different directions to illuminate different regions 56 of eye 58, as shown by arrows 102. For example, SRG 100 may diffract light 4 at a first wavelength into waveguide 32 in a first direction to illuminate region 58-1 (FIG. 6), as shown by arrow 102-1. SRG 100 may diffract light 4 at a second wavelength into waveguide 32 in a second direction to illuminate region 58-2 (FIG. 6), as shown by arrow 102-2. SRG 100 may diffract light 4 at an Nth wavelength into waveguide 32 in an Nth direction to illuminate region 58-N (FIG. 6), as shown by arrow 102-N. SRG 100 may conversely direct reflected light 4R from each of the regions onto the same output angle towards infrared sensor(s) 6 (FIG. 1), which may be a 1D camera in these implementations if desired. The example of FIG. 7 in which SRG 100 reflects light 4 and reflected light 4R is merely illustrative. In other implementations, SRG 100 may transmit light 4 and reflected light 4R in the corresponding directions. Such an SRG may, for example, be layered onto a lateral surface of waveguide 32 or disposed elsewhere in the optical coupler. SRG 100 of FIG. 7 may be replaced with louvered mirrors or constant pitch gratings (e.g., volume holograms) if desired.

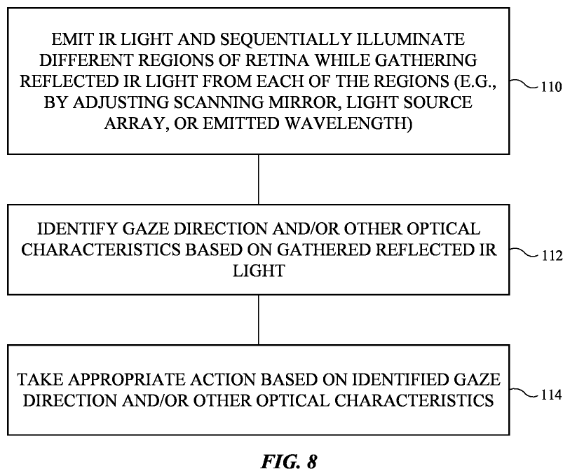

FIG. 8 is a flow chart of illustrative operations involved in performing optical sensing at eye box 24 (e.g., gaze tracking) using gaze tracking sensor 40 and optical system 22 by sequentially illuminating different portions of an eye box in accordance with some embodiments.

At operation 110, infrared emitter(s) 8 may emit light 4. Optical system 22 and infrared emitter(s) 8 may sequentially illuminate N different regions 56 on eye 58 using the emitted light 4. Optical system 22 and/or infrared emitter(s) 8 may sequentially illuminate the N different regions 56 by sequentially rotating scanning mirror 42 through different orientations/angles (FIG. 3), by selectively activating different sets 72 of light sources 74 in infrared emitter(s) 8 (FIGS. 4 and 5), and/or by sequentially tuning the wavelength of the light 4 emitted by infrared emitter(s) 8 towards diffractive gratings (FIGS. 6 and 7). Optical system 22 may sequentially direct the reflected light 4R from the N different regions 56 towards infrared sensor(s) 6. Infrared sensor(s) 6 may generate optical sensor data (e.g., image data) in response to the received reflected light 4R.

At operation 112, control circuitry 16 may process the optical sensor data to identify (e.g., detect, generate, measure, sense, etc.) a gaze direction and/or other optical characteristics associated with eye 58 at eye box 24. Control circuitry 16 may, for example, detect different physiological features of eye box 24 associated with the N different regions 56 (e.g., using an object detection algorithm). Control circuitry 16 may identify the gaze direction and/or other optical characteristics associated with eye 58 based on the detected physiological features. If desired, control circuitry 16 may detect gaze by generating a gaze vector oriented in the direction of the eye's gaze. Control circuitry may track the direction of the user's gaze and/or the other optical characteristics over time.

At operation 114, control circuitry 16 may take any desired action based on the identified gaze direction and/or other optical characteristics. As one example, control circuitry 16 may adjust the image data used by projector(s) 26 (FIG. 1), may power system 10 on or off, may issue an alert, notification, or other output, may transmit information to an external server, and/or may perform any other desired operations based on the identified gaze direction and/or other optical characteristics.

By sequentially scanning over different regions 56 on eye 58, significant background signal due to diffuse scattering off skin 60, specular corneal reflections, and other potential sources can be eliminated from the optical sensor data gathered by infrared sensor(s) 6, thereby maximizing the SNR of the desired optical sensor data associated with regions 56. In implementations where each region 56 is simultaneously illuminated, light reflected from the skin creates a haze over the whole sensor as it is highly defocused. However, sequentially illuminating each region 56 only illuminates a single region 56 on the retina at any given time, thereby eliminating most of the haze caused by the skin and can be ignored by processing circuitry 16 when stitching images of each region 56 together to obtain a full image of the retina for use in gaze tracking.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

As described above, one aspect of the present technology is the gathering and use of information such as information from input-output devices. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made to the described embodiments. The foregoing embodiments may be implemented individually or in any combination.

What is claimed is:

1. A display comprising:
an optical sensor;
a waveguide;
a scanning mirror configured to reflect light into the waveguide; and
an optical coupler configured to
couple, out of the waveguide, the light reflected by the scanning mirror, and
couple reflected light into the waveguide, wherein the scanning mirror is configured to reflect, towards the optical sensor, the reflected light coupled into the waveguide by the optical coupler.

2. The display of claim 1, further comprising:
a prism mounted to the waveguide, wherein the scanning mirror is configured to receive the light and the reflected light through the prism.

3. The display of claim 2, wherein the optical coupler comprises a diffractive grating.

4. The display of claim 1, further comprising:
an optical emitter configured to emit the light towards the scanning minor.

5. The display of claim 4, wherein the optical sensor comprises:
a camera configured to receive the reflected light from the scanning mirror.

6. The display of claim 5, wherein the light comprises infrared light and the reflected light comprises reflected infrared light.

7. The display of claim 6, further comprising:
a projector configured to generate additional light that contains images, wherein the waveguide is configured to propagate the additional light via total internal reflection.

8. The display of claim 1, wherein the scanning mirror comprises a micro-electromechanical systems (MEMs) mirror.

9. The display of claim 1, wherein the scanning mirror has a first orientation and a second orientation different from the first orientation, the optical coupler being configured to:
couple the light out of the waveguide in a first direction while the scanning mirror has the first orientation,
couple the reflected light into the waveguide from the first direction while the scanning mirror has the first orientation,
couple the light out of the waveguide in a second direction different from the first direction while the scanning mirror has the second orientation, and
couple the reflected light into the waveguide from the second direction while the scanning mirror has the second orientation.

10. A display comprising:
an array of light sources, wherein the light sources are arranged in sets and the array of light sources is configured to emit light by sequentially activating each of the sets;
a waveguide;
a first optical coupler configured to couple, into the waveguide, the light emitted by the array of light sources; and
a second optical coupler, wherein
the second optical coupler is configured to couple, out of the waveguide, the light coupled into the waveguide by the first optical coupler,
the second optical coupler is configured to couple, into of the waveguide, reflected light associated with the light emitted by the array of light sources, and
the first optical coupler is configured to couple, out of the waveguide, the reflected light coupled into the waveguide by the second optical coupler.

11. The display of claim 10, wherein the light sources comprise vertical-cavity surface-emitting lasers (VCSELs).

12. The display of claim 10, wherein the second optical coupler is configured to couple the light out of the waveguide in a first direction when a first set in the array of light sources is active and is configured to couple the light out of the waveguide in a second direction that is different from the first direction when a second set in the array of light sources is active.

13. The display of claim 12, wherein the first set comprises a first column of the array of light sources and the second set comprises a second column of the array of light sources.

14. The display of claim 10, further comprising:
a camera configured to receive the reflected light coupled out of the waveguide by the first optical coupler.

15. The display of claim 14, wherein the first optical coupler comprises:
a first optical wedge;
a second optical wedge; and
a beam splitter between the first optical wedge and the second optical wedge.

16. The display of claim 15, wherein the beam splitter comprises a reflective polarizer configured to reflect the light and to transmit the reflected light

17. The display of claim 10, further comprising:
a first diffuser between the array of light sources and the first optical coupler and configured to transmit the light; and
a second diffuser between the first diffuser and the optical coupler and configured to transmit the light, wherein the first diffuser comprises a two-dimensional (2D) diffuser and the second diffuser comprises a one-dimensional (1D) diffuser.

18. A display comprising:
an optical sensor;
a light source configured to emit first light of a first wavelength at a first time and configured to emit second light of a second wavelength that is different from the first wavelength at a second time;
a waveguide; and
diffractive gratings coupled to the waveguide and configured to
diffract the first light in a first direction,
diffract the second light in a second direction different from the first direction,
diffract first reflected light of the first wavelength from the first direction towards the optical sensor, and
diffract second reflected light of the second wavelength from the second direction towards the optical sensor.

19. The display of claim 18, further comprising:
a prism mounted to the waveguide, wherein the diffractive gratings comprise a surface relief grating (SRG) or a constant pitch grating on the prism.

20. The display of claim 18, wherein the diffractive gratings comprise:
a grating medium on the waveguide;
a first volume hologram in the grating medium and configured to diffract the first light and the first reflected light; and
a second volume hologram in the grating medium and configured to diffract the second light and the second reflected light, wherein the first and second volume holograms are superimposed in a same volume of the grating medium.
